(19) United States
(12) Patent Application Publication
(10) Pub. No.: US 2005/0188326 A1
(43) Pub. Date: Aug. 25, 2005

(54) Image assortment supporting device

(75) Inventor: Takeshi Ikeda, Tokyo (JP)

Correspondence Address: Liniak, Berenato & White, Ste. 240, 6550 Rock Spring Drive, Bethesda, MD, 20817, US

(73) Assignee: TRIWORKS CORP.

(21) Appl. No.: 10/925,999

(22) Filed: Aug. 26, 2004

(30) Foreign Application Priority Data
Feb. 25, 2004 (JP) 2004-049369

(51) Int. Cl. G06F 17/00

(52) U.S. Cl. 715/788; 715/838; 715/835; 715/810; 715/790; 715/793; 715/797; 715/767; 715/769; 715/852

(57) ABSTRACT

An image assortment supporting device displays an assortment window allocated including an assortment view R2 and a sorting view R4 on a display screen of a display unit of a computer. A sight of thumbnail images is displayed in the assortment view R2. The assortment of original images is performed by moving the thumbnail image from the assortment view R2 to the sorting view R4 according to the user operation. Accordingly, the user can assort the images (pictures) on the display screen of the display unit of the computer as if the user spreads printed pictures on a desk.

### FIELD OF THE INVENTION

The present invention relates to an image assortment supporting device, a method for the same and a program therefore, in which images (pictures) are displayed on a computer display screen so that a user can assort the images as if the user spreads printed pictures on a desk.

### BACKGROUND OF THE INVENTION

Today mass digital data image are collected through internet, digital cameras and scanners. There have been developed devices and programs for easily viewing and enjoying the obtained pictures on a computer. For example, for a PC (personal Computer), a program for displaying images is installed and runs on the PC to display the obtained images stored in a storage medium, e.g., kinds of removable media and a hard disk. As one of the image displaying programs, there is a Japanese patent laid-open No. 2000-261749 in which original images are displayed as predetermined scaled down thumbnail images in a matrix form on the display screen. FIG. 1 is a view showing a conventional display screen. In FIG. 1, an image sight region 501 is allocated in a window 500 and plural thumbnail images 502 (502a, 502b, 502c, . . . ) are displayed in the image sight region 501.

### SUMMARY OF THE INVENTION

It is an object of the invention to provide an image assortment supporting device, a method for the same and a program therefore, in which images (pictures) are displayed on a computer display screen so that a user can assort the images as if the user spreads printed pictures on a desk.

In order to accomplish the object, an image assortment supporting device of the present invention comprise 1) an original image storing means for storing an original image to be assorted into the storage unit, 2) an attribute storing means for storing attribute of the original image as attribute database, 3) an assortment window allocating means for allocating an assortment window in a part or a whole of a frame image displayed on a display screen of a display unit, 4) an assortment view allocating means for allocating an assortment view in which a thumbnail image of the original image is displayed in the assortment window allocated by the assortment window allocating means, 5) a reading means for reading the original image to be assorted and the attribute of the original image from the storing means, 6) a thumbnail image forming means for forming a predetermined scaled thumbnail image of the original image read by the reading means, 7) a view image forming means for forming a view image to arrange all the thumbnail images based on the attribute of the original images, 8) a view image fitting means for fitting the view image into the assortment view, 9) a frame image forming image for forming a frame image for each frame including a part of the assortment window or whole of the assortment window, 10) a frame storing means for temporally storing the frame image into a frame storage unit, 11) a displaying means for displaying the frame image temporally stored in the frame storage unit on the display screen of the display unit, and 12) an assortment operating means for performing select operation, move operation and copy operation onto the thumbnail image in the view image fitted in the assortment view when the assortment window is displayed on the display screen of the display unit.

Further, the image assortment supporting device may comprise a sorting view allocating means for allocating a sorting view to which the thumbnail image displayed in the assortment view is assorted, and a fitting location determining means for determining whether the view image is fitted to the assortment view or the sorting view. The view image fitting means fits the view image into one of the assortment view and the sorting view based on the determination of the fitting location determining means.

The assortment operating means perform the select operation, the move operation and the copy operation onto the thumbnail image in the view image fitted in the assortment view and moves and copies the thumbnail image from the assortment view to the sorting view when the assortment window including the assortment view and the sorting view is displayed on the display screen of the display unit.

Furthermore, the image assortment supporting device may comprise a recording means which stores the original image into the storage unit with the original image storing means and which stores the attribute of the original image into the storage unit as attribute database with the attribute storing means and which forms a new view image including the original image arranged in the view image of the assortment view with the view image forming means to display the new view image as the assortment view.

Further, the image assortment supporting device may comprise a grouping means for outputting a group of the original images corresponding to the thumbnail images assorted by the assortment operating means.

According to the image assortment supporting device, a sight of all thumbnail images are displayed in the assortment view, so that a user can assort the original images by assorting the thumbnail images as if the user spreads printed pictures on a desk.

A method of supporting an image assortment of the present invention comprises a step of allocating an assortment window in a part or whole of frame image displayed on a display screen of a display unit, a step of allocating an assortment view in which thumbnail images are displayed and assorted into the assortment window, a step of reading an original image to be assorted and attribute of the original image from a storage unit, a step of forming a thumbnail image having a predetermined scale of the original image read from the step of reading, a step of forming a view image in which the thumbnail images are all displayed in the assortment view based on the attributes of the original image, a step of fitting the view image into the assortment view, a step of forming a frame image for each frame including a part of the assortment window or whole of the assortment window allocated in the step of allocation the assortment window, a step of temporally storing the frame image into a frame storage unit, a step of displaying the frame image temporally stored in the frame storage unit on a display screen of the display unit, and a step of performing the assortment operations including select operation, move operation and copy operation onto the thumbnail images in the view image fitted in the assortment view when the assortment window including the assortment view is displayed on the display screen of the display unit.

An image assortment supporting program executable on a computer and makes the computer to function as an original image storing means for storing an original image to be assorted into the storage unit, an attribute storing means for storing attribute of the original image as attribute database, an assortment window allocating means for allocating an assortment window in a part or a whole of a frame image displayed on a display screen of a display unit, an assortment view allocating means for allocating an assortment view in which a thumbnail image of the original image is displayed in the assortment window allocated by the assortment window allocating means, a thumbnail image forming means for forming a predetermined scaled thumbnail image of the original image read by the reading means, a view image forming means for forming a view image to arrange all the thumbnail images based on the attribute of the original images, a view image fitting means for fitting the view image into the assortment view, and an assortment operating means for performing select operation, move operation and copy operation onto the thumbnail image in the view image fitted in the assortment view when the assortment window is displayed on the display screen of the display unit.

### BRIEF DESCRIPTION OF THE DRAWINGS

FIG. 1 is a view illustrating a conventional sight.

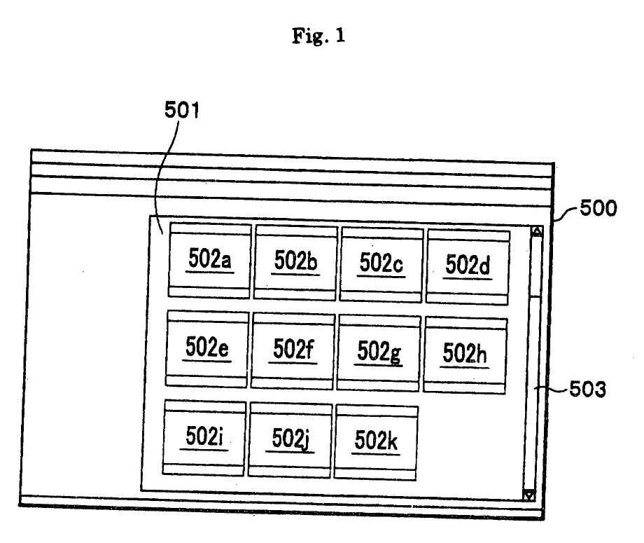

FIG. 2 is a perspective view showing outside structure of an image assortment supporting device according to one embodiment of the present invention.

FIG. 3 is a block diagram showing the functional structure of the image assortment supporting device according to one embodiment of the present invention.

FIG. 4 is an assorting window displayed by the image assortment supporting device according to the embodiment of the present invention.

FIG. 5 is a flowchart showing the image assortment supporting processes with the image assortment supporting device according to the embodiment of the present invention.

FIGS. 6A and 6B are views showing the concept of the thumbnail image formation with the image assortment supporting device according to the embodiment of the present invention. FIG. 6A illustrates the original image and FIG. 6B illustrates the thumbnail image.

FIGS. 7A and 7B are views showing the thumbnail images displayed in random. FIG. 7A illustrates the arrangement of small overlapping area and FIG. 7B illustrates the arrangement of large overlapping area.

FIGS. 8A to 8Q are views showing the arrangement in a matrix form. FIGS. 8A to 8Q show the different numbers of thumbnail images.

FIG. 9 is a flowchart showing step of recording in the image assortment supporting process with the image assortment supporting device according to the embodiment of the present invention.

FIG. 10 is a flowchart for describing steps of arranging thumbnail images in random of the image assortment supporting process with the image assortment supporting device according to the embodiment of the present invention.

FIG. 11 is a flowchart describing a step of lining up thumbnail images.

FIG. 12 is a flowchart showing the assortment procedure of the assortment supporting process with the image assortment supporting device according to the embodiment of the present invention.

FIG. 13 is a flowchart showing the sorting procedure of the assortment supporting process with the image assortment supporting device according to the embodiment of the present invention.

FIG. 14 is a view showing the concept of select, move, copy of the thumbnail image in the assortment view with the image assortment supporting device according to the embodiment of the present invention.

FIG. 15 is a view showing the concept of processing procedure of the thumbnail image in the assortment view with the image assortment supporting device according to the embodiment of the present invention.

### DETAILED DESCRIPTION OF THE PRESENT INVENTION

The preferred embodiment of the present invention will be described with the accompanying drawings.

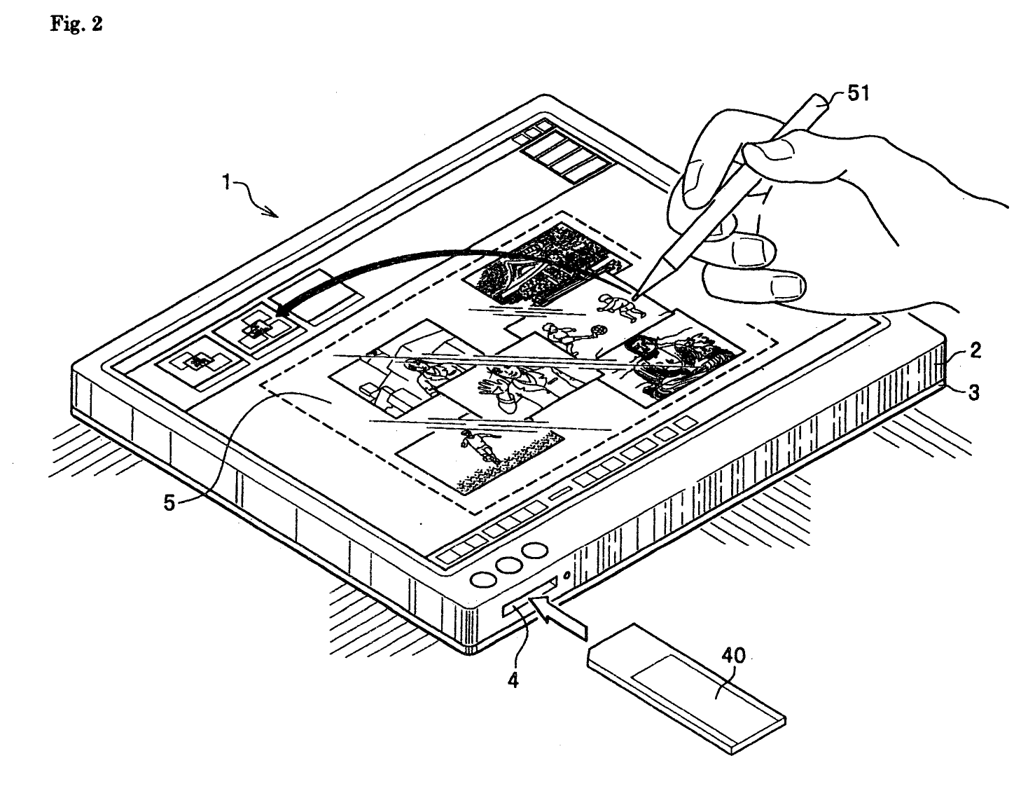

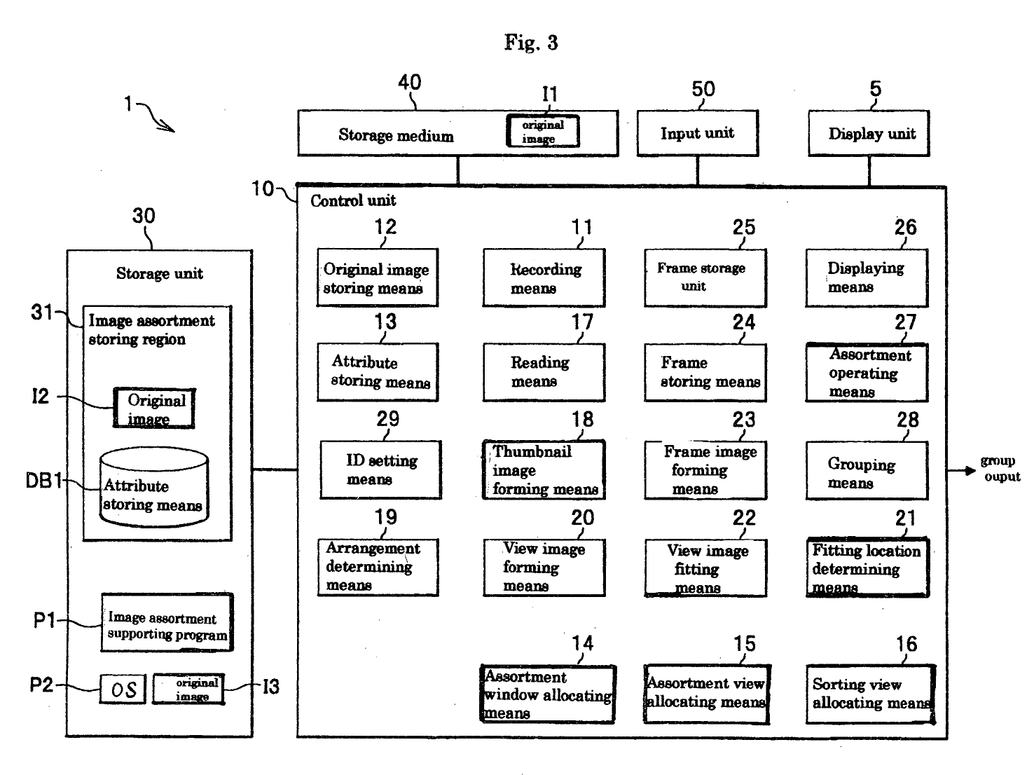

First, referring to FIG. 2, outside structure of an image assortment supporting device 1 will be explained. FIG. 2 is a perspective view showing the outside structure of the image assortment supporting device 1 according to the embodiment of the present invention. The image assortment supporting device 1 comprises an upper cover body 2 and a lower cover body 3 to form a closed body of device. There is a slot 4 formed at a side of the upper cover body 2. A removable medium 40 is inserted into the slot 4. Further, a display unit 5 is provided on the top surface of the upper cover body 2. The display unit 5 may be formed, e.g., by a liquid crystal display (LCD). The display unit 5 is covered with a touch panel (input unit 50, see FIG. 3) which includes transparent electrodes and which is not shown. The display unit 5 and the touch panel constitute a touch screen. When the touch screen is touched by a finger or a pen device 51, the electrode at the location where touched is conducted and the input information of the corresponding coordinate is transmitted to an electric device such as an IC (not shown).

Further, the image assortment supporting device 1 may comprise interfaces such as a terminal for connecting a LAN (Local Area Network) cable and an antenna for connecting wireless LAN, so that images can download through the network, e.g., connecting the internet over the interface.

Furthermore, the closed body contains a printed circuit board (not shown) which is located under the display unit 5 and which electrically connects the display unit 5 and on which IC chips (not shown), storage medium (not shown) and others are mounted. An external power source terminal (not shown) which is mounted on the printed circuit board is exposed from the side of the upper cover body 2 so that the power can be supplied from an external power source.

The closed body also contains a battery pack electrically connected with the printed circuit board, so that when the power is not supplied from the external power source, power can be supplied to the electronic devices such as IC chips.

The image assortment supporting device 1 allocates an assortment window on a display screen of the display unit 5, displays all images as thumbnail images having predetermined display scale on an assortment view allocated in the assortment window and makes a user select, move, copy the thumbnail images. Therefore, the thumbnail images read from storage medium 40 are all displayed on the display screen, and the thumbnail images can be assorted by tapping the display screen with a pen device 51, using the pointer operation, e.g., drag and drop.

There is a device called Stylus pen as a pen device 51. The Stylus pen is used with an operating system, Windows CE (Trademark of Microsoft). For the Stylus pen, click and double click operations of a mouse are called tap and double tap, respectively. In the present embodiment, tap and double tap are used to explain the operations of the pen device 51; however, the operating system is not limed to the Windows CE.

Next, the image assortment supporting device will be described in detail.

First, referring to FIG. 3 (and FIG. 2), the structure of the image assortment supporting device will be explained. FIG. 3 is a block diagram showing the functional structure of the image assortment supporting device 1. In FIG. 3, the image assortment supporting device 1 comprises a controlling unit 10 for processing the image assortment supporting process, a storage unit 30 for storing image assortment supporting program P1, operating system (OS) P2, kinds of programs and images, a storage medium 40, an input unit 50 and a display unit 5.

The controlling unit 10 comprises a CPU (Central Processing Unit) for carrying out almost all information processing, which is not shown, ROM (Read Only Memory) for storing kinds of programs and data, which is not shown, and RAM (Random Access Memory) which is not shown. In the controlling unit 10, when the CPU loads the image assortment supporting program P1 and OS (P2) from the storage unit 30 to the RAM and carries out the processes, a recording means 11, an original image storing means 12, an attribute storing means 13, an assortment window allocating means 14, an assortment view allocating means 15, a distributing view allocating means 16, a reading means 17, a thumbnail image forming means 18, an arrangement determining means 19, a view image forming means 20, a fitting location determining means 21, a view image fitting means 22, a frame image forming means 23, a frame storing means 24, a displaying means 26, an assortment operating means 27, a grouping means 28, and an ID (identification) setting means 29 are all functioned.

The recording means 11 controls the process of reading an original image I1 from the storage medium 40, reading an original image I3 from the storage unit 30, recording and storing the original images as the images I2 in an image assortment supporting storage region 31 of the storage unit 30, using the original image storing means 12. The recording means 11 also controls the process of writing the attribute (described later) of the original image I2 into attribute database DB1 the attribute storing means and the process of forming new view images in which the original images I2 are arranged at the arbitrary location on the view images, using the view image forming means 20.

The image assortment supporting storage region 31 stores data which can be processed under the image assortment supporting process when the controlling unit 10 carries out the image assortment supporting program P1. Accordingly, the controlling unit 10 cannot carry out the image assortment supporting process onto the data outside the image assortment supporting storage region 31. Therefore, the image assortment supporting device 1 needs to store the original image I1 or the original image I3 as the original image I2 in the image assortment supporting storage region 31, using the original image storing means 12 under the control of the recording means 11.

The original images I1 in the storage medium 40 are subjects to be assorted by a user with the image assortment supporting device 1. The original images I3 which are in the storage unit 30 and outside the image assortment supporting storage region 31 are also the subjects to be assorted by a user with the image assortment supporting device 1.

The difference between the original image I1 and the original image I3 is simply the storing location. Therefore, the original image I1 and the original image I3 may be identical and may not be identical. For example, in a case of nonidentity, the original image I1 taken by a digital camera and the original image I3 is obtained by downloading through the internet. On the other hand, in a case of identity, for example, the image I1 is taken by a digital camera is read from the storage medium 40 and stored as the image I3 in the image assortment supporting storage region 31 of the storage unit 30.

Further, the original image I2 in the image assortment supporting storage region 31 is an image when the original image I1 or the original image I3 is loaded in the image assortment supporting storage region 31. Accordingly, there are both cases that the original image I2 and the original image I1 are identical and that the original image I2 and the original image I3 are identical.

The original image storing means 12 stores the original images I1, I3 in the image assortment supporting storage region 31 allocated in the storage unit 30. The image assortment supporting storage region 31 are allocated as the region for storing kinds of data to be processed with the image assortment supporting program P1 under the control of OS (P2).

The original image storing means 12 may store the thumbnail image formed from the original image I2 in the image assortment supporting storage region 31 of the storage unit 30. Further, the original image storing means 12 may delete the original image I2 which is no longer used by the image assortment supporting device 1. For example, if the corresponding thumbnail image is deleted from both an assortment view R2 and a sorting view R4, which will be described later, by a user, the original image I2 is also deleted.

The attribute storing means 13 stores the attribute of the original image I2 stored in the image assortment supporting storage region 31 into the attribute database DB1. Further, when the thumbnail image of the original image I2 is formed, the attribute storing means 13 rewrites its attribute. Furthermore, when copy or move command is operated, the attribute storing means 13 also rewrites its attribute. Here, the attribute to be stored in the attribute database DB1 will be explained. The attribute includes a header, image information and view information.

The header is information of distinguishing mark. The distinguishing mark is information of identification such as an assortment view ID, a sorting view ID, a maximum image ID and others. The information of these IDs can be registered as the attribute in the attribute database DB1. However, it is preferable that the information of ID is assigned every time the image assortment supporting device 1 is driven. If the information of ID is assigned each time, the data amount can be less, so that the storage region of the storage unit 30 can be used effectively. Here, a case that information of each ID is stored in the attribute database DB1 as the attribute will be explained but a case that information of each ID is assigned every time the image assortment supporting device 1 is driven will be described later.

The assortment view ID is to distinguish the image whether it is displayed as an assortment view. The sorting view ID is to determine the order of displaying the image as a sorting view. The maximum image ID is to assign the size of the assortment view. The image information is attribute corresponding to the original image. For example, for one image, there are an image ID, an original image file storing path, a type of image, a view ID, position of image, a rotating angle, size of original image, a name of a original image file, zorder, and label information (memo, font, background color, font color). Here, the image ID is for specifying the thumbnail image. The original image file storing path indicates the location where the original image I2 is stored in the image assortment supporting storage region 31.

The image type is used to specify the order of data sequence when the image is stored as the digital data and to load the program which is so called viewer and which is able to display the corresponding type of image. It is preferable to use the type called “bitmap graphics” in which the image is stored as the group of dots but the type called “vector graphics” in which the image is stored as the group of figure such as line and plane can be used. For example, as bitmap graphics, there are PNG (Portable Network Graphics), JPEG (Joint Photographic Experts Group), GIF (Graphic Interchange Format), BMP (Bit MaP) and TIFF (Tagged Image File Format). On the other hand, as vector graphics, there is application software called CAD (Computer Aided Design).

A subject view ID is used to determine the thumbnail image of the original image to be displayed in either the assortment view or the sorting view. The position of image is information to be used to determine the initial position when the image is displayed on the corresponding assortment view or the sorting view. The rotating angle is information to be used to determine the rotating angle when the rotation is added to the thumbnail image. The size of original image is a size of the original image I2 stored in the image assortment supporting storage region 31 of the storage unit 30. The file name of the original image is the file name of the original image I2. The file name is assigned when the image is stored in the image assortment supporting storage region 31. The file name can be the same as the file name of the original image I1 or the original image I3. However, when the original image I2 is already stored, new file name is assigned. For example, in a case that the original image I3 is stored as the original image I2 in the image assortment supporting storage region 31, in order to store the original image I1 having the same file name as the original image I3, the original image I1 is stored with the file name to which the suffix or prefix is added the file name.

Zorder is a variable used for displaying a thumbnail image having a small value in front when a plurality of thumbnail images are displayed over another. The zorder of the last recorded original image is set to have the smallest value every time the original images are recorded. Accordingly, the view image forming means 20 can form the view image of thumbnail images arranged in layers.

The label information (memo, font information, background color, font color) is used for character inputs into the assortment view as a label. The label is treated as one of thumbnail images in the assortment view. For example, the thumbnail image having the type of BMP and the yellow background color is formed, and characters are entered in the yellow background color of the thumbnail image according to the predetermined font information having the character color of black. Accordingly, the label can be displayed as the thumbnail image in the assortment view.

The view information is related to the assortment view and the sorting view. For example, there are a view ID, a view size, a display scale, a scroll position and a view name. The view size is used to assign the size of the assortment view when it is displayed first time. The display scale is used to assign the display scale of the assortment view in the assortment window. The scroll position is used to assign the location of the assortment view in the assortment window. The view name is assigned to each view when the assortment view and the sorting view are displayed. The first displayed assortment view is initially named “desk 1”, and every time the sorting view is added, it is named “desk 2”, “desk 3” . . . The name can arbitrary be changed by a user.

In FIG. 3, the assortment window allocating means 14 allocates the assortment window on a part of the frame image or entire frame image displayed on the display screen of the display unit 5.

The assortment view allocating means 15 allocates the assortment view for displaying the thumbnail images in the assortment window allocated by the assortment window allocating means 14 so that the assortment can be performed.

The sorting view allocating means 16 allocates the sorting view to which the thumbnail image displayed in the assortment view is sorted.

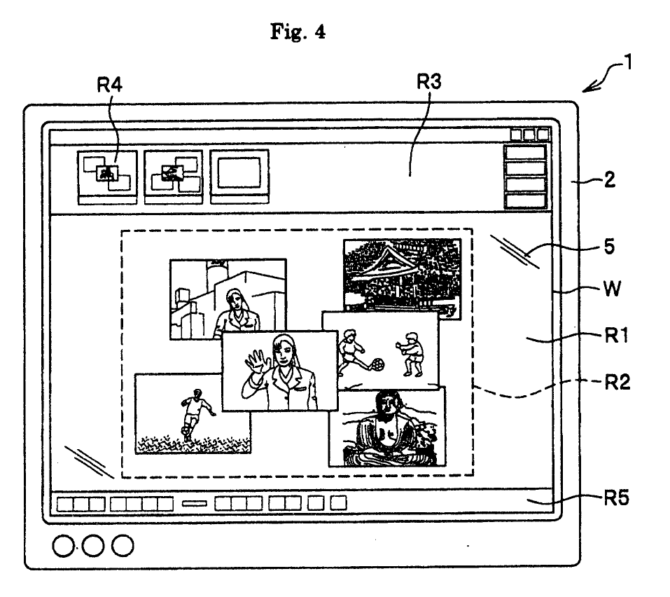

Here, referring to FIG. 4, the assorting window, the assortment view displayable region, the assortment view, the sorting view allocation region, and the sorting view will be explained in detail.

FIG. 4 shows an assorting window displayed by the image assortment supporting device 1 according to the embodiment of the present invention. Here, the assorting window W is displayed on the entire display screen of the display unit 5 exposed on the upper cover body 2 but the size of the window W is not limited to this. For example, the assorting window W can be displayed on the quarter of the display screen of the display unit 5. In the assorting window W, there displayed the assortment view displayable region R1, the assortment view R2, the sorting view allocating region R3, the sorting view R4, and the tool bar R5.

The assortment view displayable region R1 has a rectangular shape having the largest area in the assortment window W, and the assortment view is allocated and displayed in the assortment view displayable region R1. Here, a scroll bar can be displayed anywhere in the assorting window W so that a user can move the assortment view R2 vertically or horizontally. The assortment view R2 is arranged in the assortment view displayable region R1 so that the thumbnail images are displayed therein and the user can assort the images. The assorting view R2 has the oblong rectangular shape but its shape can be varied.

The sorting view allocating region R3 is a region to which the sorting views R4 are arranged. In FIG. 4, the sorting view allocating region R3 is displayed above the display of the assortment view displayable region R1 but it can be displayed below, left, and right of the region R1. The thumbnail image displayed in the assortment view R2 is moved or copied into the sorting view R4. When the thumbnail image is copied or moved, the image can be displayed on the entire sorting view R4 or reduced to the desired size. Here, in the sorting view allocating region R3, it is preferable to display an add button for adding the sorting view R4, a name change button for changing a name of the sorting view R4, a delete button for deleting the sorting view R4 and other buttons. Further, a blank is provided near the sorting view R4 to display a name such as“desk1”.

The tool bar R5 includes buttons for selecting kinds of operations. When the button is selected, the controlling unit 10 (see FIG. 3) loads and runs the corresponding program from the storage unit 30 (see FIG. 3). As the buttons, there are a mode switching button, a switching button for switching the display and non-display of the sorting view R4, a display size switching button, an image recording button, a lineup button, a random display button, an undo button, a redo button and a help button. The mode switching button includes an assortment button for selecting a normal mode in which the assortment operation is performed, a hand tool button for moving the assortment view in the assortment view displayable region R1 horizontally or vertically, and a label forming button.

When the assortment button is selected, the controlling unit 10 performs the image assortment process under the image assortment supporting program P1.

When the hand tool button is selected, the controlling unit 10 recognizes that the pen device 51 (see FIG. 2) is tapped in the assortment view R2 and moves in the assortment view R2 vertically or horizontally corresponding to the movement of the pen device 51 while tapped.

When the label forming button is selected, the controlling unit 10 displays the character input region as the label in the assortment view R2 so that characters can be entered.

When the switching button for switching the display and non-display of the sorting view R4 is selected, the controlling unit 10 deletes the sorting view allocating region R3 not to display the sorting view R4, and displays the assortment displayable region R1 scaled up to the location where the sorting view allocating region R3 was allocated.

As the display size switching button, there are a button for scaling down and up the display size of the assortment view R2, a button for displaying the assortment view R2 with a predetermined displaying scale, a displaying scale box for displaying the displaying scales of the assortment view R2 and other buttons. The controlling unit 10 displays the assortment view R2 with the selected displaying scale in the assortment displayable region R1.

The image recording button makes the controlling unit 10 functioning as the recording means 11.

The lineup button is used to display all thumbnail images in a matrix form in the assortment view R2 by the controlling unit 10.

The random display button is used to display all the thumbnail images in random in the assortment view R2.

The undo button is used to replace the proceeded result put back by the redo button.

The redo button is used to put back the proceeded result.

The help button is used to display the order of procedure for users.

Referring back to FIG. 3, the reading means 17 loads the original image I2 and the attribute database DB1 of the original image I2 from the image assortment storage region 31.

The thumbnail image forming means 18 forms the predetermined scaled thumbnail image from the original image I2 read by the reading means 17. Here, the thumbnail image of the original image I2 formed by the thumbnail image forming means 18 is preferably kept in the controlling unit 10 and stored in the storage region of the image assortment supporting storage region 31.

The arrangement determining means 19 determines the arrangement pattern of the thumbnail image in the view image. The arrangement pattern can be designated by a user input. Alternately, the arrangement pattern can be recorded in the arbitrary region of the image assortment supporting storage region 31 of the storage unit 30. As the arrangement patter, there are an arrangement pattern when recorded, a random arrangement pattern and a matrix form lineup arrangement pattern.

In the description,“matrix form” means the form determined by two axes perpendicularly intersecting the other. For example, the form is not limited to a rectangle determined by two axes perpendicularly intersecting the other but the form may be a parallelogram determined by two axes not perpendicularly intersecting the other. The form may have unmatched two axes. For example, the images in the second row is indented from the first row, and the images in the third rows start the same position as the images in the first rows, which look like steps alternately arranged.

The view image forming means 20 forms a view image in which thumbnail images are all arranged in the assortment view R2 and the sorting view R4 based on the attribute of the original image in accordance with the arrangement pattern determined by the arrangement determining means 19.

Further, when the original image I1 or the original image I3 is recorded and stored in the image assortment supporting storage region 31 as the original image I2, the view image forming means 20 forms new view image including the entire original image I2 to be displayed over the currently displayed view image in the assortment view R2.

For the arrangement pattern when recorded, if the size of n-th original image can fit in the assortment view R2, the original image is displayed in the assortment view R2 as it is. If the (n+1)th original image is larger than the assortment view R2, the original image is reduced to fit in the assortment view R2 and displayed in the determined position. The position of the (n+1)th original image may not relate with the position of the n-th original image. In other words, the n-th original image can be covered with the (n+1)th original image because it is important that the user notifies that the (n+1)th original image is recorded.

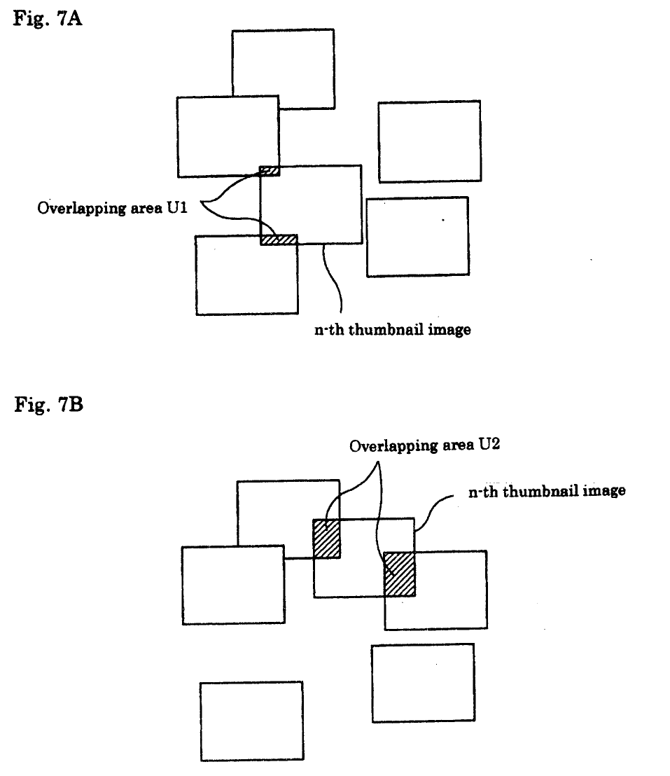

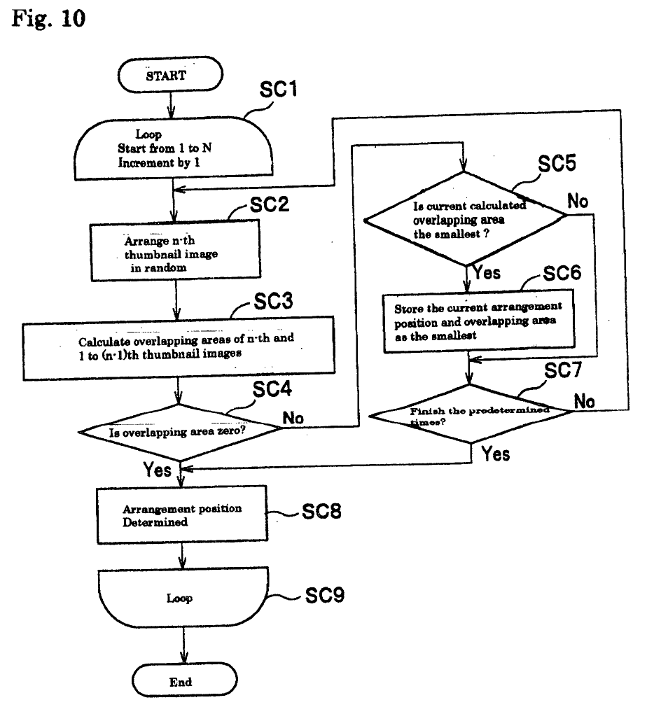

When the thumbnail images are displayed in random, the images can be arranged in both ways that they do not overlap to the others and that they overlap to the others. In a case of images overlapping, as shown in FIGS. 7 and 10, when n-th thumbnail image is arranged in random, the overlapping area of the n-th thumbnail image and the (n−1)th thumbnail image which is already arranged is calculated. Then, the arrangement and calculation are repeated at a predetermined times so that the n-th thumbnail image is arranged at the location where the overlapping area is the smallest. It is preferable to process all thumbnail images for determining the arrangement position. Since the overlapping area is made smallest, the thumbnail images can be arranged almost uniformly. When all of the thumbnail images are arranged in random, the image assortment supporting device 1 displays all images as if the printed pictures spread out on a desk.

The frequency (predetermined times) can arbitrary be set. It should be noted that if the frequency is a small number, the probability of the overlapping area becoming large is high and that if the frequency is a large number, the probability of the overlapping area becoming small is high. Therefore, the frequency is preferably a large number. However, since the execution time of forming and outputting the thumbnail images becomes longer proportional to the frequency or the number of displaying images, the frequency is determined so that a user comfortably assorts the images. The frequency can be varied according to the computer circumstances or the number of displaying images.

The view image forming means 20 forms the view image in which the thumbnail images are all arranged, which will be described later. When the thumbnail images are all arranged in a matrix form, the image assortment supporting device 1 displays all images as if the printed pictures spread out in a matrix form on a desk.

The fitting location determining means 21 determines whether the view image formed by the view image forming means 20 is fitted into the assortment view R2 or the sorting view based on the attribute of the original image stored in the attribute database DB1.

The view image fitting means 22 fits the view image into the assortment view R2 or the sorting view R4.

The frame image forming means 23 forms a frame image for each frame including a part of the assortment window W or whole assortment window W allocated by the assortment window allocating means 14.

The frame storing means 24 temporary stores the frame image formed by the frame image forming means 23 into the frame storage unit 25.

The frame storage unit 25 stores the frame image with the frame storing means 24, and in particular stores the display image for the display unit 5. For example, as the frame storage unit 25, VRAM (Video Random Access Memory) can be used.

The displaying means 26 displays the frame image temporary stored in the frame storage unit 25 on the display unit 5.

The assortment operating means 27 performs the select operation, the move operation or the copy operation onto the thumbnail images in the view image fitted into the assortment view R2 when the assortment window W allocating the assortment view R2 is displayed on the display screen of the display unit 5 as a part of the frame image or the whole frame image.

The select operation can be performed by tapping the pen device 51 when the pointer is on the thumbnail image. Further, in order to select plural thumbnail images at the same time, the selecting range is designated by surrounding plural thumbnail images with the pointer. The range can be designated with a rectangular frame by touching the touch screen on the upper left of each thumbnail image with the pen device 51, moving the pen device 51 to the lower right while keep touching, and moving the pen device 51 away from the touch screen of the display unit 5.

Further, the move operation and the copy operation can be performed in that the pen device 51 slides on the display screen of the display unit 5 so that one or plural thumbnail images moves on the screen of the display unit 5, that is called drag and drop. Here, the move operation and the copy operation can be distinguished by pressing the shift key while drag and drop.

The grouping means 28 outputs a group of the original images corresponding to the thumbnail images assorted with the select operation, the move operation or the copy operation of the assortment operating means 27. The output is transmitted to, for example, the storage medium 40, a folder outside the region of the image assortment supporting storage region 31 of the storage unit 30, a printer (not shown) for printing, and the storage region of the network computer. Here, the original image can be deleted from the image assortment supporting storage region 31 of the storage unit by moving other than copying it to the sorting area.

The ID setting means 29 controls to store the ID information into the attribute database DB1 when the ID information is treated as the attribute. For example, when the original image I2 is recorded, at the initial setting and at increase and decrease of the number of assortment views, each of ID information is set.

Further, the ID setting means 29 analyzes the original image I2 and the attribute database DB1, and sets each ID information when each ID information is assigned every time the image assortment supporting device 1 starts driving. The ID setting means 29 keeps each of ID information in the RAM (not shown) while the image assortment supporting device 1 runs. The ID setting means 29 allocates the assortment window W, the assortment view R2 and the sorting view R3 and processes the display of the thumbnail images.

(Description of Storage Unit 30)

The storage unit 30 is readable and writable kinds of programs and kinds of data to be read and written by the controlling unit 10. As the storage unit 30, for example, a mass storage hard disk can be used. However, it is not limited to the hard disk if storage is sufficient for storing the original image I2, kinds of data and kinds of programs.

As described above, the storage unit 30 stores the program such as OS (P2) and the image assortment supporting program P1, and kinds of data such as the original image I3. The image assortment supporting storage region 31 of the storage unit 30, which is allocated by the control of the OS (P2) stores kinds of data to be processed by the image assortment supporting program, the original image I2 by the original image storing means 12 under the control of the recording means 11 and the attribute database DB1 by the attribute storing means 13. It is noted that the original image I3 is stored in a folder allocated in the storage unit 30 other than the image assortment supporting storage region 31.

Further, the storage medium 40 stores the original image I1 obtained from a digital camera or scanner, which is not shown. The storage medium 40 may be a memory card such as Memory Stick (Trademark of Sony Inc.), or a disk type storage medium such as a DVD (Digital Versatile Disk), or a removable medium which is readable and writable through a USB (Universal Serial Bus).

The input unit 50 is used by a user to select, move, and copy the thumbnail image and to proceed other operations. The input unit 50 can be a touch screen that a user enters his operation by touching the screen with a finger or the pen device 51 (see FIG. 2), a mouse, a pointing device and a keyboard.

The display unit 5 is preferably an LCD (Liquid Crystal display) but a PDP (Plasma Display Panel) and a CRT display (Cathode Ray Tube Display) can be used. As described above, the input unit 50 (touch panel) and the display unit 5 constitute the touch screen.

The image assortment supporting device 1 is achieved by running a program on a general computer and driving an arithmetic unit and a storage unit. The program (image assortment supporting program) can be distributed by communications network or a recording medium such as CD-ROM.

(Operation of the Image Assortment Supporting Device)

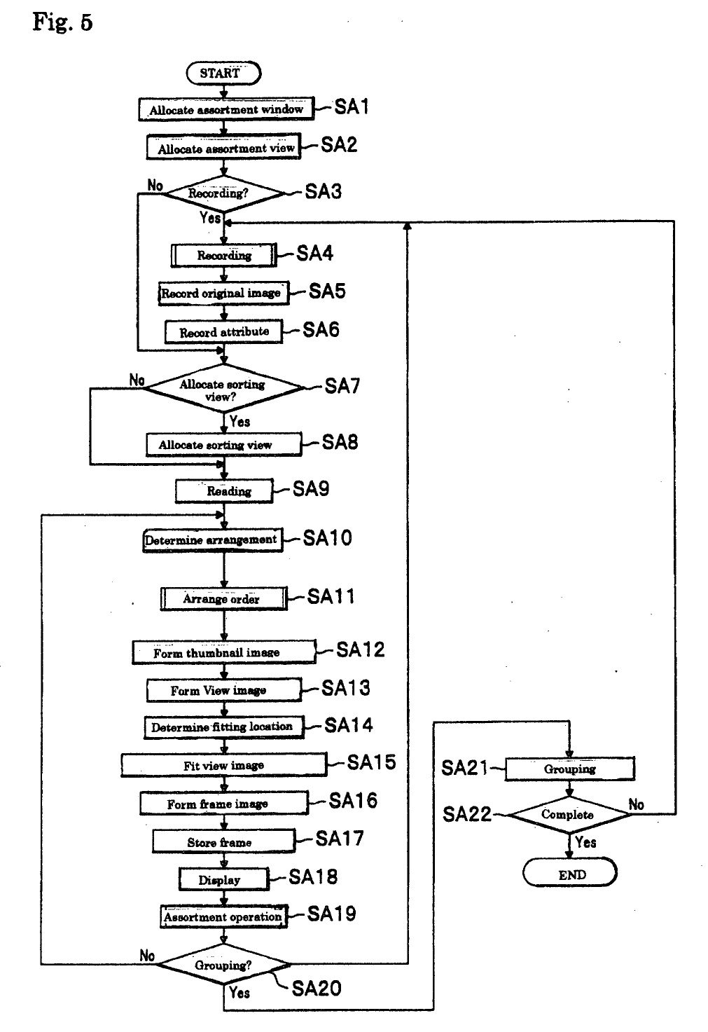

FIG. 5 is a flowchart showing the image assortment supporting processes with the image assortment supporting device. Referring to FIGS. 2 to 4, each step will be described.

(Step of Allocating Assortment Window)

First, in the image assortment supporting device 1, the control unit 10 allocates the assortment window W on the display screen of the display unit 5 using the assortment window allocating means 14 (Step SA1).

(Step of Allocating Assortment View)

Next, the control unit 10 allocates the assortment view R2 in the assortment window W and waits a user response using the assortment view allocating means 15 (Step SA2). Then, the control unit 10 recognizes the user response and if the response is the record operation, the process is moved to Step SA4 and if not, the process is moved to Step SA7.

(Step of Recording)

The control unit 10 controls the original image storing means 12 and the attribute storing means 13 using the recording means 11 to start processing a step of recording an original image in Step SA5 and a step of recording attribute in Step SA6 (Step SA4).

The recording means 11 transmits a command signal to make determination of the arrangement pattern when record to the arrangement determining means 19, so that the thumbnail images of all recorded original images I2 are displayed at a predetermined scale.

(Step of Storing an Original Image)

The recording means 11 of the control unit 10 stores the original image I1 or I3 as the original image I2 into the image assortment supporting storage region 31 allocated in the storage unit 30 (Step SA5).

(Step of Storing Attribute)

The recording means 11 of the control unit 10 stores the attribute of the original image I2 stored in the image assortment supporting storage region 31 into the attribute database DB1 using the attribute storing means 13 (Step SA6).

(Step of Allocating a Sorting View)

The control unit 10 determines whether the sorting view R4 is allocated in the sorting view allocating region R3 using the assortment view allocating means 16. If it is allocated, the process is moved to Step SA8 and if not, the process is moved to Step SA9.

The control unit 10 allocates the sorting view R4 to which the thumbnail image displayed in the assortment view R2 is sorted in the assortment window W using the assortment view allocating means 16 (Step SA8).

(Step of Reading)

The control unit 10 uses the reading means 17 to read the attribute database DB1 corresponding to the original image I2 to be assorted from the image assortment supporting storage region 31. (Step of Determining Arrangement)

The control unit 10 uses the arrangement determining means 19 to determine the arrangement of the thumbnail images in the view image. The arrangement is determined by the information of position in the view image and the arrangement pattern. The information of position is to determine the position of logical coordinates of the view image. For example, it is expressed by the coordinates where the left upper corner of the rectangular thumbnail image is located. As the arrangement pattern, there are an arrangement pattern when recorded, a random arrangement pattern and a matrix form lineup arrangement pattern. The arrangement pattern can be recorded in the arbitrary region of the image assortment supporting storage region 31 of the storage unit 30. Here, the arrangement pattern is selected by a user input (Step SA10).

(Step of Arrangement)

If the n-th original image fits in the assortment view R2, the control unit 10 arranges the n-th original image at the predetermined position of the assortment view R2 as it is. If the (n+1) image is larger than the size of the assortment view R2, the original imaged is scaled down so as to fit in the assortment view R2. Then, the control unit 10 arranges the scaled down images (Step SA11).

The control unit 10 arranges the thumbnail images in an order of arrangement in the assortment view R2 or the sorting view R4. The arrangement order is determined based on the attribute of the attributed database DB1. For example, the thumbnail images are arranged in a file name order. At this point, the thumbnail images may be arranged. Alternately, a sign indicating an order is added to the ID assigning the thumbnail image and all thumbnail images can be arranged in a view image which will be described later.

(Step of Forming a Thumbnail Image)

The control unit 10 uses the thumbnail image forming means 18 to form the thumbnail image having the predetermined scale from the original image I2 (Step SA12). The thumbnail image formed by the thumbnail image forming means 18 is kept in the control unit 10 and stored in the image assortment supporting storage region 31 of the storage unit 30.

(Step of Forming a View Image)

The control unit 10 uses the view image forming means 20 to form a view image in which all thumbnail images are arranged in the assortment view R2 or the sorting view R4 in accordance with the arrangement pattern determined by the arrangement determining means 19 (Step SA13). When the thumbnail images are displayed in layers, the control unit 10 uses the view image forming means 20 to display the thumbnail image of the original image last recorded on top in accordance with the zorder stored in the attribute database DB1.

(Step of Determining the Fitting Location)

The control unit 10 uses the fitting location determining means 21 to determine whether the view image formed by the view image forming means 20 is fitted in the assortment view R2 or the sorting view R4 on the basis of the attribute stored in the attribute database DB1 (Step SA14). It should be noted that when recorded, the assortment view R2 is selected.

(Step of Fitting a View Image)

The control unit 10 uses the view image fitting means 22 to fit the view image into the assortment view R2 or the sorting view R4, which is determined by the fitting location determining means 21 (Step SA15).

(Step of Forming a Frame Image)

The control unit 10 uses the frame image forming means 23 to form each frame image including a part or all of the assortment window W allocated by the assortment window allocating means 14 (Step SA16).

(Step of Storing a Frame)

The control unit 10 uses the frame storing means 24 to temporary store the frame image formed by the frame image forming means 23 into the frame storing unit 25 (Step SA17).

(Step of Display)

The control unit 10 uses the displaying means 27 to activate the select operation, the move operation and the copy operation for the thumbnail images displayed in the assortment view R2, wait for the user's operation and performs the assortment according to the user's operation (Step SA19).

If the user's operation is the grouping operating, the control unit 10 proceeds to Step SA21, and if not, it proceeds back to Step SA10. If the other image is recorded, it proceeds back to Step SA4.

(Step of Grouping)

The control unit 10 uses the grouping means 28 to output a group of the original images corresponding to the thumbnail images assorted by selecting, moving and coping with the assortment operating means 27. The output is transmitted to, for example, the storage medium 40, a folder outside the region of the image assortment supporting storage region 31 of the storage unit 30, a printer (not shown) for printing, and the storage region of the network computer. Here, the original image can be deleted from the image assortment supporting storage region 31 of the storage unit 30 by moving it to the sorting area, not copying it to the sorting area (Step SA21).

After grouping process, the control unit 10 determines whether the image assortment supporting process is finished. If not finished, the process is back to Step SA4 and if the finish button (not shown) is selected, the image assortment supporting process is finished. It should be noted that if the finish button is pressed during the process of the image assortment, the process is terminated and finished.

The image assortment supporting device 1 operates the above-described operations consecutively so that a user can assort the original images by viewing the thumbnail images.

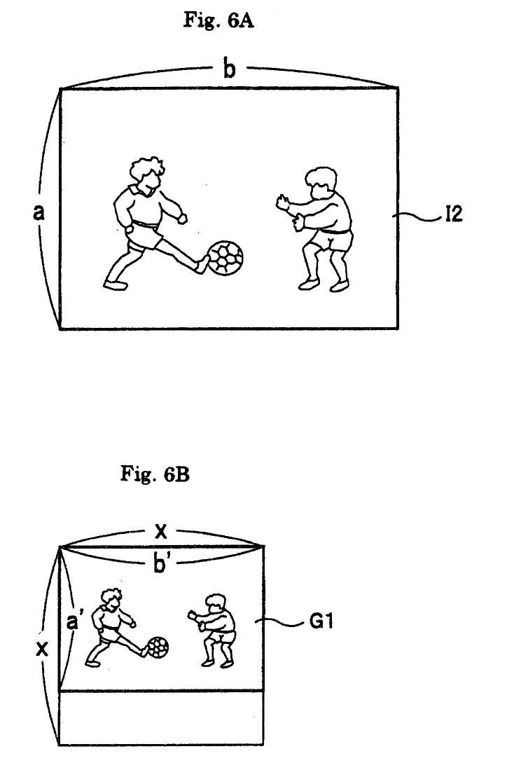

FIGS. 6A and 6B explain the concept of the thumbnail image formation with the image assortment supporting device according to the embodiment of the present invention. FIG. 6A illustrates the original image and FIG. 6B illustrates the thumbnail image.

As shown in FIG. 6A, the original image I2 has a size of height a and width b. As shown in FIG. 6B, the thumbnail image G1 having height a′ and width b′ is formed by changing the scale of the original image I2. Here, the ratio of height and width of the thumbnail image G1 is the same as the one of the original image I2.

Further, it is preferable to arrange the thumbnail image G1 in the square having one side of the length x so as to be internally touched. Assuming the numbers of squares having one side of the length X being N sum of areas of N numbers of squares being equal to the area S of the image sight region, the following equation is given.
N×x²=S

Accordingly, x=√(S/N).

The N numbers of original images I2 are scaled down or up so as to be internally touched to the square, so that the sum of areas of N numbers of thumbnail images can be substantially the same as the area S of the assortment view R2. Accordingly, the thumbnail image G1 has the preferable size to be arranged in the assortment view R2 having the area S.

It should be noted that the value of x corresponds to a pixel of the original image. Therefore, decimal points are omitted and if x is zero after rounded off, x is preferably set to 1.

FIGS. 7A and 7B are views showing the thumbnail images displayed in random. FIG. 7A illustrates the arrangement of small overlapping area and FIG. 7B illustrates the arrangement of large overlapping area.

Plural thumbnail images are arranged in random. When an n-th thumbnail image is to be arranged, thumbnail images up to a (n−1)th image are already arranged. In order to determine the arranging position of the n-th thumbnail image, the n-th thumbnail image is arranged in the trial arranging position at a predetermined times. Then, the arranging position is determined where the overlapping area of the n-th thumbnail image to the other thumbnail images is smallest. For example, comparing an overlapping area U1 in FIG. 7A with an overlapping area U2 in FIG. 7B, U1 is small. Accordingly, the n-th thumbnail image is arranged at the position of FIG. 7A. In this example, the arranging position is determined by the second trial.

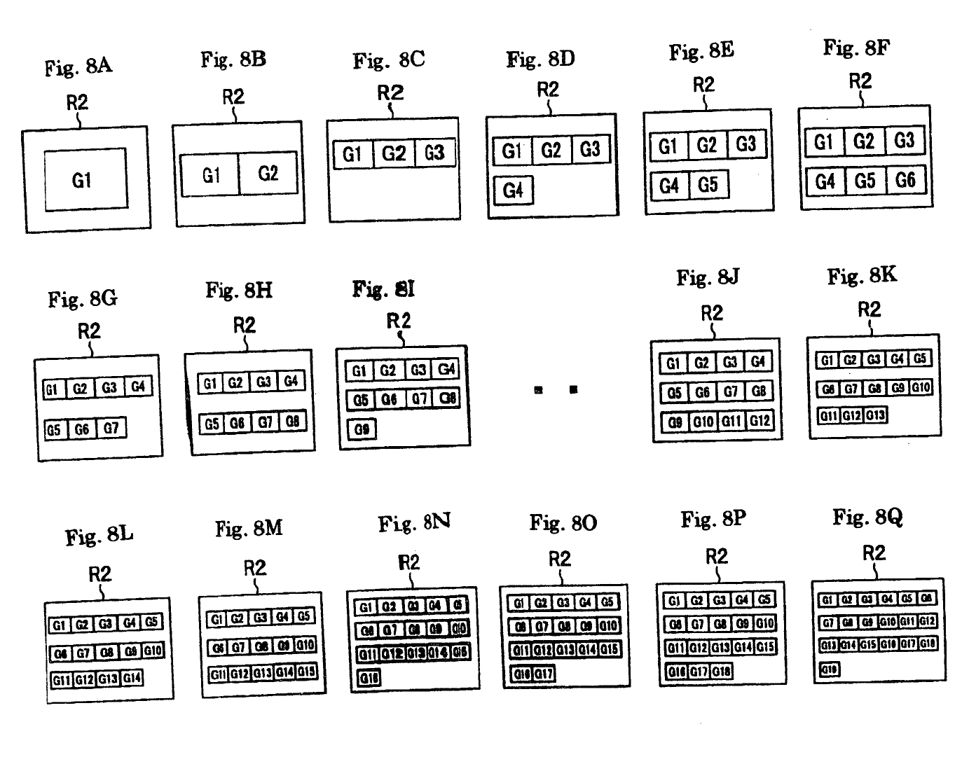

FIGS. 8A to 8Q are views showing the arrangement in a matrix form. FIGS. 8A to 8Q show the different numbers of thumbnail images. In figures, G1 to G19 denote thumbnail images displayed in the assortment view R2. The thumbnail images are arranged in numerical order.

One thumbnail image G1 is arranged at the center of the assortment view R2 (FIG. 8A). Two thumbnail images G1, G2 are arranged in the matrix form of one row and two columns in the assortment view R2 (FIG. 8B). Three thumbnail images G1, G2, G3 are arranged in the matrix from of one row and three columns (FIG. 8C). Four thumbnail images G1, G2, G3, G4 are arranged in the matrix form of tow rows and three columns (FIG. 8D). Here, two spaces are blank. Since the thumbnail images in FIGS. 8E to 8Q are arranged in the same way as above, the explanation will be omitted. It should be noted that the arrangement is not limited to these figures and that it can be varied in many ways unless all thumbnail images are displayed in the matrix form.

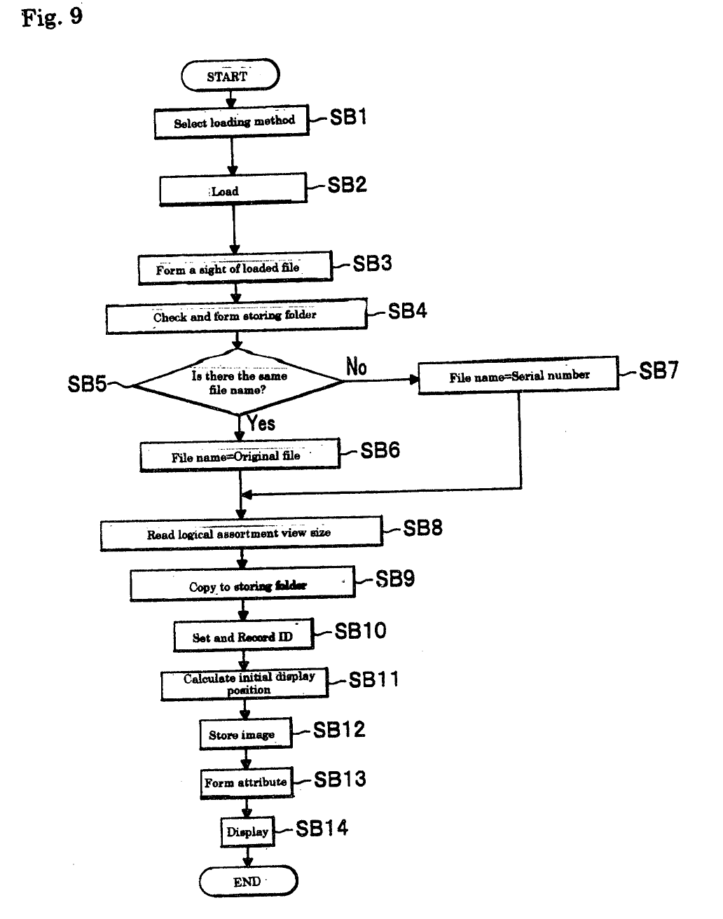

FIG. 9 is a flowchart showing the step of recording in the image assortment supporting process.

(Step of Selecting a Loading Method)

The control unit 10 uses the recording means 11 to start the recording process and select a method of loading the original image in accordance with the user's operation (Step SB1). There are three loading methods, a D & D (drag and drop) loading process, a media loading process and a designated file loading process.

In the D & D loading process, the control unit 10 opens a folder storing the original image according to the user's operation. It should be noted that the folder is allocated in the storage unit 30 other than the image assortment supporting storage region 31 and that the original image I3 is stored in the folder. In the media loading process and the designated file loading process, first the control unit 10 displays the button to make the user select the loading process. If the media loading process is selected, the control unit 10 accesses the storage medium 40 and makes the user to select a folder containing the original image I1. On the other hand, if the designated file loading process is selected, the control unit 10 accesses the storage unit 30 and makes the user select a folder containing the original image.

(Step of Forming a Sight of Loading Files)

The control unit 10 forms a sight of loading files of the original images and displays it on the display unit 5 (Step SB3). Here, in a case of the D&D loading process, the control unit 10 proceeds to the following process in order to display the original image as the thumbnail image. Here, the original image to be loaded can be displayed as an icon, not as the thumbnail image. The control unit 10 copies the original image from the folder to the assortment view R2 according to the user's drag and drop operation.

In a case of the media loading process and the designated file loading process, the control unit 10 displays a sight of the loading files and after the original image is selected, the control unit 10 loads the original image as the loading button is tapped by the pen device 51. The control unit 10 proceeds to the following process in order to display the thumbnail image of the original imaged loaded in the assortment view R2.

(Step of Checking and Making a Storing Folder)

The control unit 10 checks a storing folder in the image assortment supporting storage region 31 of the storage unit 30, and if it does not exist, the control unit 10 makes a storing folder (Step SB4).

(Step of Naming a File)

The control unit 10 checks if there is the same file name as the original image to be loaded or not. if no file is found, the process is moved to Step SB6. On the other hand, if the file having the same name is found, the process is moved to Step SB7 and a file is named, e.g., by a serial number (Step SB7).

(Step of Writing)

The control unit 10 reads the logical assortment view size (Step SB8), loads the original image provided with the file name and writes the original image into the storing folder (Step SB9). Then, the control unit 10 sets an ID and stores the ID into the attribute database DB1 (Step SB10). Next, the control unit 10 calculates the initial display position based on the attribute of the original image and the logical assortment view size (Step SB11). Thereafter, the control unit 10 treats the original image written in the storing folder as already recorded (Step SB12), completes the attribute database DB1 (Step SB13) and displays the thumbnail image at the initial display position calculated in Step SB13 (Step SB14).

It should be noted that when the size of the original image fits in the assortment view R2, the thumbnail image having the same size as the original image can be displayed and that when the size of the original image is lager than the assortment view R2, the thumbnail image is scaled down to fit the assortment view R2.

FIG. 20 is a flowchart for describing steps of arranging thumbnail images in random in the image assortment supporting process according to the image assortment supporting device of the embodiment of the present invention.

(Loop Step)

The arrangement determining means 19 starts arranging an n-th thumbnail image among N thumbnail images. Here, a (n−1)th thumbnail image is already arranged.

(Step of Arrangement)

The arrangement determining means 19 arranges the n-th thumbnail image in the image sight region in which the (n−1)th thumbnail image is already arranged (Step SC2).

(Step of Calculating an Overlapping Area)

The arrangement determining means 19 calculates an overlapping area of the n-th thumbnail image and the (n−1)th thumbnail image (Step SC3).

(Step of Determining an Overlapping Area)

The arrangement determining means 19 determines whether the overlapping area calculated in Step SC3 is zero. If it is zero, the process is moved to Step SC8, and if not, the process is moved to Step SC5.

(Step of Comparing Overlapping Areas)

In a case that the overlapping area is not zero, the arrangement determining means 19 compares the current overlapping area with the smallest overlapping area. If the current overlapping area is smaller, the process is moved to Step SC6. If the current overlapping area is equal to or larger, the process is moved to Step SC7. When the process is the first time, the process is moved to Step SC6.

(Step of Renewing the Position Where the Overlapping Area is the Smallest)

The arrangement determining means 19 stores the current overlapping area and the arrangement position where the overlapping area is the smallest to renew the arrangement position where the overlapping area is the smallest and to renew the smallest overlapping area (Step SC6). It should be noted that at the first time process, the arrangement position and the overlapping area of the processing image is stored.

(Step of Determining the Number of Processes)

The arrangement determining means 19 determines the number of arranging processes for n-th thumbnail image. If it does reach a predetermined times, the process is back to Step SC2, and the n-th thumbnail image is arranged in random again. If it reaches the predetermined times, the process is moved to Step SC8. The predetermined time can be varied in many ways, for example, ten thousands times.

(Step of Determining the Arrangement Position)

The arrangement determining means 19 determines the arrangement position of the n-th thumbnail image (Step SC8). If the last step is Step SC4, the arrangement position is determined to the position where the overlapping area is zero. If the last step is Step SC6, the arrangement position is determined to the position where the overlapping area is the smallest, which is renewed in Step SC6.

(Loop Step)

The arrangement determining means 19 finish the process for n-th thumbnail image since the position of the n-th thumbnail image is determined (Step SC9). In such the above-described ways, the thumbnail images are consequently positioned, and N thumbnail images are arranged. Here, the sequence of arranging the N thumbnail images can be changed. For example, the thumbnail images are arranged in the order so that the thumbnail images are stored in the storage unit 30.

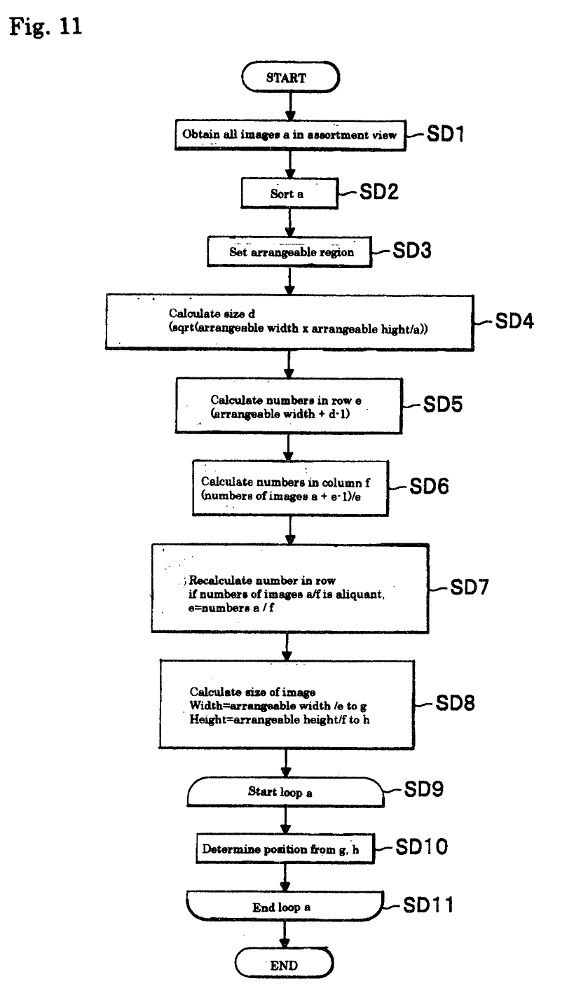

FIG. 11 is a flowchart describing a step of lining up thumbnail images. In the below, the width means the concept of line in row and the height means the concept of line in column.

The arrangement determining means 19 obtains all original images displayed in the assortment view R2 (Step SD1). Here, a group of the obtained original images is denoted as “a”. The arrangement determining means 19 sorts the obtained images “a”on a predetermined basis (Step SD2). The predetermined basis can be the attribute. For example, the attribute to be used as the basis are a file name (alphabetical order), date orders (descending order or ascending order), size order of original image (descending order or ascending order) and others.

Next, the arrangement determining means 19 sets the size of the assortment view R2 (arrange-able region) (STEP SD3). The arrangement determining means 19 calculates the size of the display of thumbnail images (STEP SD4). The size is calculated on the basis that the assortment view R2 is divided into small squares and that one thumbnail image is arranged in a small square. Assuming a square having one side x=d, one side d is given by “sqrt” (arrange-able width×arrange-able height X the number of images “a”). Here, an operator “sqrt” has a positive solution of square root.

Further, the arrangement determining means 19 calculates the number e of images in row by e=(arrange able width+d−1)/d (Step SD5). Here, the solution of this equation, (arrange-able width/d), rounds up. The arrangement determining means 19 calculates the number f of images in column by f=(the number a+e−1)/e (Step SD6). Furthermore, the arrangement determining means 19 recalculates the number e of images by e=the number a/f when the number a/f is divided out (Step SD7).

Next, the arrangement determining means 19 calculates the size of the thumbnail image to be displayed (Step SD8). The length in the horizontal direction of the thumbnail image is calculated by the width g=arrange-able width/e, and the length in the vertical direction is calculated by the height h=arrange-able height/f. Thereafter, the arrangement determining means 19 arranges all thumbnail images having the size determined by the calculated length g and h into the assortment view R2 in a matrix form in the sort order of Step SD2 (Step SD9, SD19, SD11).

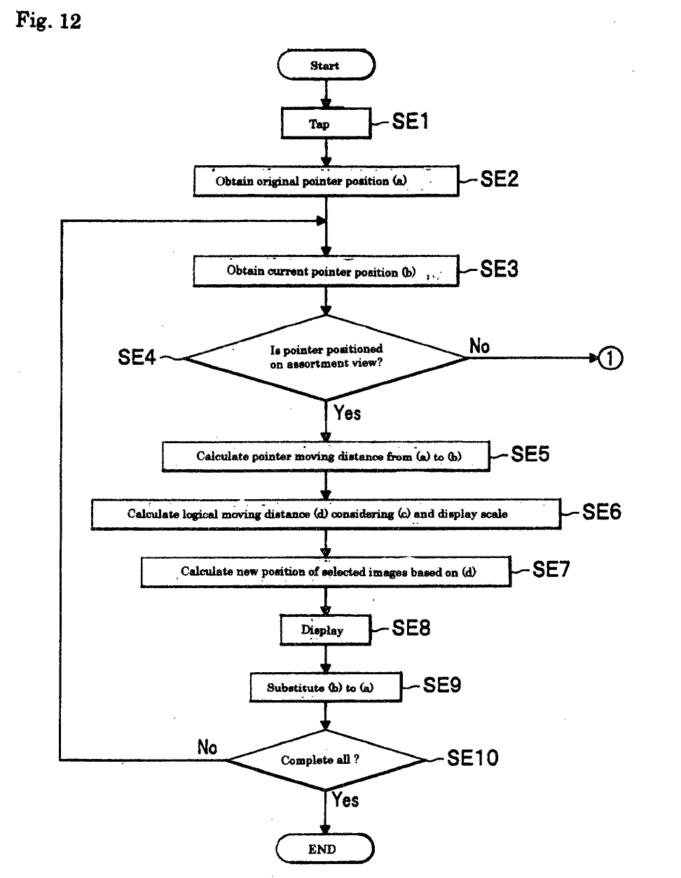

FIG. 12 is a flowchart describing the assortment procedures with the image assortment supporting device according to the present embodiment of the present invention.

When a user taps the display screen of the display unit 5 with the pen device 51, the control unit 10 displays a pointer at the position where the user tapped (Step SE1). Next, when the user taps and moves the pen device 51 on the display screen of the display unit 5, the control unit 10 obtains an original pointer position (a) (Step SE2) and moves the pointer as the pen device 51 moves. At this point, the control unit 10 obtains the current pointer position (b) (Step SE3).

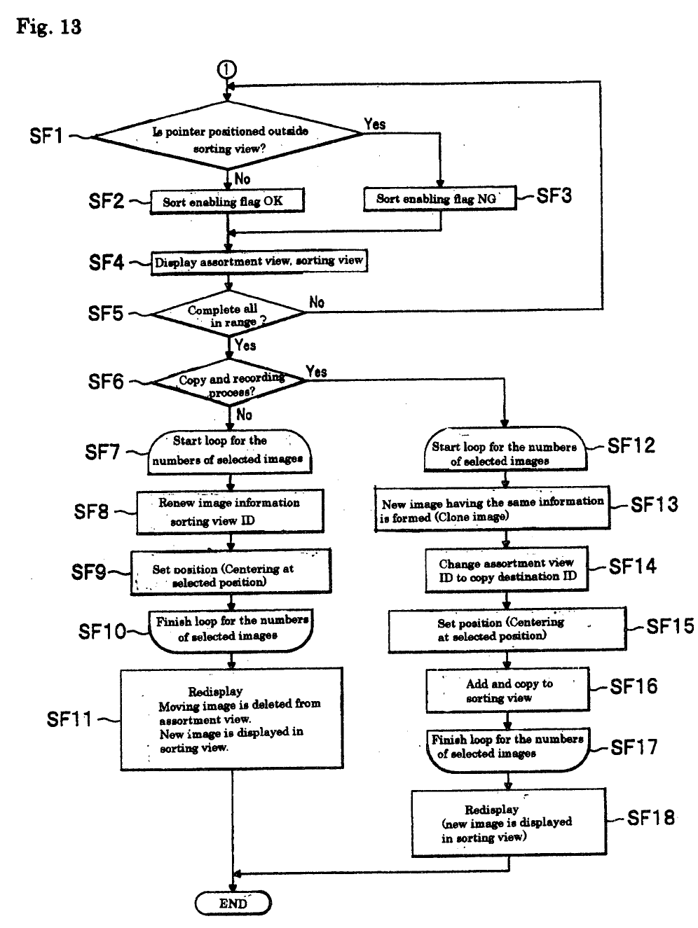

Further, the control unit 10 proceeds to Step SE5 for the assortment process when the pointer position is located on the assortment view R2. On the other hand, the control unit 10 proceeds to Step SF1 (see FIG. 13) for the sorting process when the pointer position is not located on the assortment view R2.

In the case of the assortment process, the assortment operating means 28 obtains the distance between the pointer positions (a) and (b), calculates the moving distance of pointer (c) (Step SE5) and calculates a logical moving distance (d) in accordance with the calculated pointer moving distance (c) and the display scale of the assortment view R2 (Step SE6). Next, the assortment operating means 27 calculates a new position of all selected images based on the calculated logical moving distance (d) (Step SE7). In other words, the control unit 10 converts the pointer moving distance into the logical moving distance, forms the logical images moved by the logical moving distance, and displays the logical image in the logical space on the display screen of the display unit 5 (Step SE8). Therefore, the thumbnail images can be moved and copied in the assortment view R2, and the user can perform the assortment in the assortment view R2.

Next, the assortment operating means 27 assigns the current pointer position (b) into the original pointer position (a) and replaces the current pointer position (b) by the original pointer position (a) (Step SE9). Thereafter, the assortment operating means 27 proceeds to Step SE3 if the pointer keeps moving. On the other hand, the assortment operating means 27 stops processing if the pointer is stopped. The assortment operating means 27 repeats the processes Step SE3 to SE10 at a predetermined time interval.

In a case of yes in Step SE4, the assortment operating means 27 proceeds the following processes. FIG. 13 is a flowchart describing the sorting procedure with the image assortment supporting device according to the present embodiment of the present invention.

When the pointer is not located on the assortment view R2, which is determined in Step SE4, the assortment operating means 27 further determines whether the pointer is located in the sorting view R4 and proceeds to Step SF3 if the pointer is located outside thereof (yes in Step SF1).

Further, when the pointer is not located in the assortment view R2, which is determined in Step SE4, if the assortment operating means 27 determines that the pointer is not located outside the sorting view R4 in Step SF1, the sorting process can be performed. The process is moved to Step SF2 (No in Step SF1).

The assortment operating means 27 sets a flag for enabling sort in Steps SF2, SF3. The sort enabling flag becomes OK when the pointer is located in the sorting view R4. If No in Step SF1, the assortment operating means 27 sets the sort enabling flag to OK since the pointer is located in the sorting view R4 (Step SF2). On the other hand, if the pointer is located outside the sorting view R4 (yes in Step SF1), the assortment operating means 27 sets the sort enabling flat to NG since the sorting process cannot be performed (Step SF3).

The assortment operating means 27 checks the sorting flag and if OK, the process is moved to Step SF6 for sorting and If NG, the process is moved back to Step SF1 until the sorting region is designated, which means that the pointer is located in the sorting view R4. Next, the assortment operating means 27 determines that the user selects the moving and recording process or the copy and recording process. For example, the selection buttons may be displayed on the screen for the user to select. The assortment operating means 27 moves the process to Step SF7 if it is the moving and recording process and moves the process to Step SF12 if it is the copying and recording process.

(Moving and Recording Process)

The assortment operating means 27 executes the process repeating by the number of selected images (Step SF7 to SF10). First, the assortment operating means 27 replaces the image information and sorting view ID read from the attribute database DB1 by new ID (Step SF8). For example, the centering is processed to set the position while the selecting position is maintained (Step SF9). The assortment operating means 27 erases the moving images from the assortment view R2 and displays the new image in the sorting view R4 (Step SF11).

(Copy and Recording Process)

The assortment operating means 27 executes the process repeating by the number of selected images (Step SF12 to SF18). First, the assortment operating means 27 forms a new image having the same image information such as the sorting view ID (called a clone image) (Step SF13), and changes the sorting view ID of the clone image by a copying location ID (Step SF14). The assortment operating means 27 adds the clone image in the sorting view R4 which is the copying location (Step SF17). Then, the assortment operating means 27 displays the clone image from the assortment view R2 in the sorting view R4 as the new image (Step SF18).

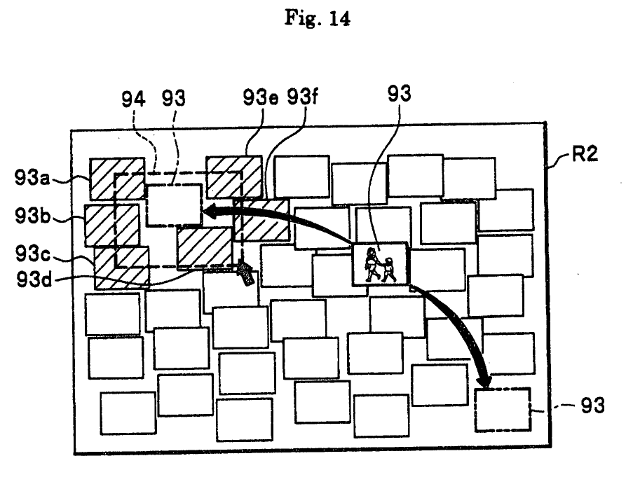

FIG. 14 is a view showing the concept of select, move and copy of the thumbnail images in the assortment view with the image assortment supporting device according to the embodiment of the present invention. Here, a case of all thumbnail images displaying in random in the assortment view R2 will be described. A case of all thumbnail images displaying in a matrix form in the assortment view R2 is the same as the case of in random, so that the description for this case will be omitted.

The thumbnail images are all displayed in random in the assortment view R2. At this point, the user selects the thumbnail image 93 by tapping with the pen device 51, drags and moves the pen device 51 while tapping to the desired position and drops. Accordingly, the thumbnail image 93 is moved or copied to the desired position, e.g., denoted by dotted lines in the assortment view R2. The plural thumbnail images 93, 93a, 93b, 93c, 93d, 93e can be all selected once, and moved or copied to the sorting view R4 or outside the assortment window W. In especially, moving or copying the thumbnail images outside the assortment window W is a group output.

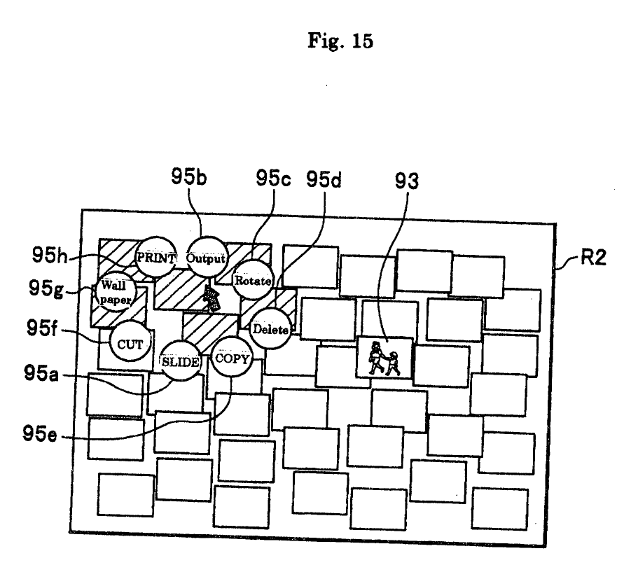

FIG. 15 is a view describing the concept of processing the thumbnail image in the assortment view with the image assortment supporting device. In FIG. 15, the thumbnail images as same as the ones shown in FIG. 14 are arranged in random in the assortment view R2 and the same reference numerals are provided. Here, for example, when plural thumbnail images are selected, the user taps the select region with the pen device 51, and then a pop-up menu 95 (95a-95h) appears on the screen.

Here, 95a denotes a button to call the original images of thumbnail image in the select region for slide show. 95b denotes a button to output the thumbnail images to a file. 95c denotes a rotation button. When the rotation button is tapped, the thumbnail images can be rotated at a desired angle at the same arrangement (for example, rotates 90 decrees in clockwise per one tap). 95d denotes a delete button. When the delete button is tapped, the thumbnail images are deleted from the assortment view R2. 95e denotes a copy button. When the copy button is tapped, the thumbnail images are copied to the desired position at the same arrangement. 95f denotes a cut button. When the cut button is tapped, the thumbnail images are cut. 95g denotes a wallpaper button. When the wallpaper button is tapped, the thumbnail images are set to the wallpaper at the same arrangement. 95h denotes a print button. When the print button is tapped, the thumbnail images are printed at the same arrangement.

The structure of the image assortment supporting device 1 has been described according to one embodiment of the present invention; however, the present invention is not limited to this. For example, the image assortment supporting program is installed in a general personal computer to function as the image assortment supporting device. The image assortment supporting program can be distributed through communication lines or by recorded medium such as a CD-ROM.

Further, in the above description, in the image assortment supporting device 1, OS (P2) includes the functions of the frame image forming means 23, the frame storing means 24 and the displaying means 26 but they can be individual programs. Further, in the above description, OS (P2) is stored in the storage unit 30 but it can directly be written in a ROM in the control unit 10. As OS, for example, there are Windows CE series (trademark of Microsoft.).

In th present embodiment, the pen device functions as the input device touching the touch screen but a pen device functioning as the input device not in contact with the touch screen can be used.

1. An image assortment supporting device comprising:
an original image storing means for storing an original image to be assorted into said storage unit;
an attribute storing means for storing attribute of said original image as attribute database;
an assortment window allocating means for allocating an assortment window in a part or a whole of a frame image displayed on a display screen of a display unit;
an assortment view allocating means for allocating an assortment view in which a thumbnail image of said original image is displayed in said assortment window allocated by said assortment window allocating means;
a reading means for reading said original image to be assorted and said attribute of said original image from said storing means;
a thumbnail image forming means for forming a predetermined scaled thumbnail image of said original image read by said reading means:
a view image forming means for forming a view image to arrange all said thumbnail images based on said attribute of said original images;
a view image fitting means for fitting said view image into said assortment view;
a frame image forming image for forming a frame image for each frame including a part of said assortment window or whole of said assortment window;
a frame storing means for temporally storing said frame image into a frame storage unit;
a displaying means for displaying said frame image temporally stored in said frame storage unit on said display screen of said display unit; and
an assortment operating means for performing select operation, move operation and copy operation onto said thumbnail image in said view image fitted in said assortment view when said assortment window is displayed on said display screen of said display unit.

2. An image assortment supporting device according to claim 1 further comprising a sorting view allocating means for allocating a sorting view to which said thumbnail image displayed in said assortment view is assorted, and
a fitting location determining means for determining whether said view image is fitted to said assortment view or said sorting view;
said view image fitting means fitting said view image into one of said assortment view and said sorting view based on the determination of said fitting location determining means;
said assortment operating means performing the select operation, the move operation and the copy operation onto said thumbnail image in said view image fitted in said assortment view and moving and copying said thumbnail image from said assortment view to said sorting view when said assortment window including said assortment view and said sorting view is displayed on said display screen of said display unit.

3. An image assortment supporting device according to claim 2 further comprising a recording means for storing said original image into said storage unit with said original image storing means,
storing said attribute of said original image into said storage unit as attribute database with said attribute storing means,
forming a new view image including said original image arranged in said view image of said assortment view with said view image forming means to display said new view image as said assortment view.

4. An image assortment supporting device according to claim 1 further comprising a grouping means for outputting a group of said original images corresponding to said thumbnail images assorted by said assortment operating means.

5. A method of supporting an image assortment comprising:
a step of allocating an assortment window in a part or whole of frame image displayed on a display screen of a display unit;
a step of allocating an assortment view in which thumbnail images are displayed and assorted into said assortment window;
a step of reading an original image to be assorted and attribute of said original image from a storage unit;
a step of forming a thumbnail image having a predetermined scale of said original image read from said step of reading;
a step of forming a view image in which said thumbnail images are all displayed in said assortment view based on said attributes of said original image;
a step of fitting said view image into said assortment view;
a step of forming a frame image for each frame including a part of said assortment window or whole of said assortment window allocated in said step of allocation said assortment window;
a step of temporally storing said frame image into a frame storage unit;
a step of displaying said frame image temporally stored in said frame storage unit on a display screen of said display unit; and
a step of performing the assortment operations including select operation, move operation and copy operation onto said thumbnail images in said view image fitted in said assortment view when said assortment window including said assortment view is displayed on said display screen of said display unit.

6. An image assortment supporting program executable on a computer and making said computer function as means of allocating an assortment window on a display screen of a display unit, allocating an assortment view in said assortment window, displaying a sight of a predetermined scaled thumbnail images of original images, copying, moving and selecting said thumbnail images for assortment of original images, said image assortment supporting program making said computer function as means comprising:
an original image storing means for storing an original image to be assorted into said storage unit;
an attribute storing means for storing attribute of said original image as attribute database;
an assortment window allocating means for allocating an assortment window in a part or a whole of a frame image displayed on a display screen of a display unit;
an assortment view allocating means for allocating an assortment view in which a thumbnail image of said original image is displayed in said assortment window allocated by said assortment window allocating means;
a thumbnail image forming means for forming a predetermined scaled thumbnail image of said original image read by said reading means:
a view image forming means for forming a view image to arrange all said thumbnail images based on said attribute of said original images;
a view image fitting means for fitting said view image into said assortment view;
an assortment operating means for performing select operation, move operation and copy operation onto said thumbnail image in said view image fitted in said assortment view when said assortment window is displayed on said display screen of said display unit.
